(19) United States
(12) Patent Application Publication
(10) Pub. No.: US 2003/0150148 A1
(43) Pub. Date: Aug. 14, 2003

(54) Cellulose film label with tactile feel

(75) Inventors: Richard Spear, Cincinnati, OH (US); Richard Fearn, Milford, OH (US)

Correspondence Address: WOOD, HERRON & EVANS, LLP, 2700 CAREW TOWER, 441 VINE STREET, CINCINNATI, OH, 45202, US

(73) Assignee: Spear U.S.A., L.L.C., Mason, OH

(21) Appl. No.: 10/350,594

(22) Filed: Jan. 24, 2003

Related U.S. Application Data
(60) Provisional application No. 60/356,283, filed on Feb. 12, 2002.
(60) Provisional application No. 60/389,633, filed on Jun. 18, 2002.
(60) Provisional application No. 60/433,414, filed on Dec. 13, 2002.

(51) Int. Cl. G09F 3/10

(52) U.S. Cl. 40/638

(57) ABSTRACT

A label is formed from cellulose film material and has embossed or debossed portions that give the label improved aesthetic appearance. The label may also include tactile coating layers to provide tactile feel to the label. The embossed or debossed portions and tactile coating layers may be applied to the label to correspond to indicia printed on the label, or may be applied to areas of the label without printed indicia.

This application claims priority under 35 U.S.C. § 119(e) to copending U.S. Provisional Patent Application Serial No. 60/356,283, filed Feb. 12, 2002; copending U.S. Provisional Patent Application Serial No. 60/89,633, filed Jun. 18, 2002; and U.S. Provisional Patent Application Serial No. 60/433,414, filed Dec. 13, 2002, each of which is herein incorporated by reference in its entirety.

### FIELD OF THE INVENTION

This invention relates to labels for containers, and more particularly to a label having improved aesthetic qualities.

### BACKGROUND OF THE INVENTION

Printed labels are widely used on containers to identify particular products, manufacturers, and brand names associated with the products in those containers. Conventional labels for containers include labels facestocks made from paper, films, and other polymeric materials. Paper-based labels typically have an opaque appearance, whereby the contents of the container are at least partially concealed from view. While paper-based labels are generally inexpensive, they are susceptible to damage, such as by abrasion or scuffing and generally exhibit poor adhesion in wet or humid environments. Opaque labels have also been made from polymeric materials, including thin films. While these materials offer improved resistance to scuffing and abrasion, as well as improved adhesion in humid conditions, opaque polymeric labels also conceal at least a portion of the product held within the container.

A recent trend in labeling containers has been towards utilizing clear thin film labels which provide a “label-less” or “printed-on” look. These labels have the advantages of improved resistance to scuffing and abrasion, and good adhesion in moist environments, and further provide improved aesthetic appearance of the containers to which they are applied. Both paper-based and polymeric labels are commonly imprinted with various graphics and text which may be applied to the labels by various methods including gravure printing, lithography, flexography, screen printing, and other methods suitable for creating the desired indicia on the labels.

To further improve the aesthetic appearance of a label, it may be desired to manufacture the label with distinct raised or depressed portions, such as on portions of the label corresponding to visible text and/or graphics for example, to give the label enhanced tactile feel. Conventional labels have raised portions corresponding to text and graphics of the labels that are created by applying successive layers of ink to the surface of the label. However, applying multiple layers of ink is time consuming and requires use of additional ink which inevitably increases the cost of such labels.

Conventional container labels described above have typically been provided in “cut-and-stack” form or roll form for application to containers by automated labeling equipment. In the cut-and-stack form, a plurality of individual labels are provided in a stack to a labeling machine, generally in a magazine, whereby the machine is configured to apply individual labels from the stack to containers as they are moved past a labeling station. The cut-and-stack labels may be provided with a pre-applied adhesive for securing the label to the containers, or the adhesive may be applied by the labeling machine immediately prior to affixing the label to the container. This method of supplying and applying labels to product containers has generally been utilized with paper-based labels.

Labels may also be provided in roll form wherein a plurality of discrete labels are provided on an elongate web of backing material that has been wound into a roll. The web of backing material is directed past a peel tip at a labeling station to transfer the label from the backing material to the individual product containers. This method of supplying labels to containers has typically been utilized with thin film and other polymeric labels. Adhesive is generally pre-applied to the labels and may be pressure sensitive or heat activated to adhere to the containers.

Polymeric labels, including thin film labels, have generally not been provided in cut-and-stack form due to various difficulties associated with providing polymeric labels in a stacked form. In particular, the polymeric materials are susceptible to developing static charges which cause the individual labels to cling to one another and to the labeling equipment, thereby hindering accurate and repeatable application of the labels to the product containers. Another factor which has hindered the provision of polymeric labels in stack form is that adhesives used in conventional cut-and-stack applications generally do not work well with polymeric materials. Furthermore, conventional cut-and-stack adhesives are not transparent. This is particularly problematic when the polymeric materials are transparent because the adhesives may be visible through the transparent label, thereby depreciating the label's aesthetic effects.

Labels provided to labeling equipment in cut-and-stack form may advantageously be applied to individual containers at very high rates, such as 1200 labels per minute or more. These high application rates are well suited for use with high-speed packaging lines. While the costs of polymeric labels, including thin film labels, has gradually decreased, paper-based labels are generally considered to be the least expensive labeling material. On the other hand, the polymeric-based labels, particularly clear, thin film labels, are generally associated with improved product appearance.

There is thus a need for a product label which provides improved aesthetic appearance, while being economically competitive to paper-based labels and capable of application to products in high speed manufacturing lines.

### SUMMARY OF THE INVENTION

The present invention provides an economical label having improved aesthetic appearance. In one aspect of the invention, the label facestock comprises a cellulose film material. The cellulose film material may be a clear film, colored opaque film, or partially transparent colored film, as may be desired. Labels according to the invention may be provided in roll form or “cut-and-stack” form for application to containers by automated labeling machines.

In another aspect of the invention, the cellulose film facestock is selectively embossed and/or debossed to provide discreet raised and/or depressed areas on the facestock and imprinted with visible indicia. The embossed or debossed areas may correspond to the visible indicia, whereby the indicia are raised or depressed with respect to surrounding portions of the label, or the embossed or debossed areas may be formed on portions of the label not corresponding to the indicia. The label may further include one or more layers of tactile coating selectively applied to the facestock. The tactile layers may be applied to areas of the label corresponding to indicia or embossed/debossed areas, or may be applied to other portions of the label to create desired effects.

In yet another aspect of the invention, a plurality of labels as described above may be arranged in a stack for provision to an automated label machine adapted to receive labels in “cut-and-stack” form. The plurality of labels may also be provided in roll form to accommodate automated labeling machines adapted to receive rolls of labels.

In another aspect of the invention, a labeled product package comprises a container having a label disposed on its surface. The label is formed from a cellulose film material and is provided with embossed and/or debossed areas and printed indicia that enhance the label's aesthetic appearance.

In yet another aspect of the invention, a method of making labels according to the present invention includes selectively embossing and/or debossing areas of a cellulose film material and selectively printing indicia on the cellulose film material.

The features and objectives of the present invention will become more readily apparent from the following Detailed Description taken in conjunction with the accompanying drawings.

### BRIEF DESCRIPTION OF THE DRAWINGS

The accompanying drawings, which are incorporated in and constitute a part of this specification, illustrate embodiments of the invention and, together with a general description of the invention given above, and the detailed description given below, serve to explain the invention.

FIG. 1 is a plan view depicting an exemplary label of the present invention;

FIG. 2 is cross-sectional view of the label of FIG. 1, taken along line 2-2;

FIG. 3 is a cross-sectional view depicting another exemplary label of the present invention;

FIG. 4 is a cross-sectional view of another exemplary label of the present invention;

FIG. 5 is a cross-sectional view of another exemplary label of the present invention;

FIG. 6 is a perspective view of labels of FIG. 1 arranged in a stack;

FIG. 7 is a perspective view of a plurality of labels of FIG. 1, provided in a roll; and

FIG. 8 is a perspective view of an exemplary container including a label of FIG. 1.

### DETAILED DESCRIPTION

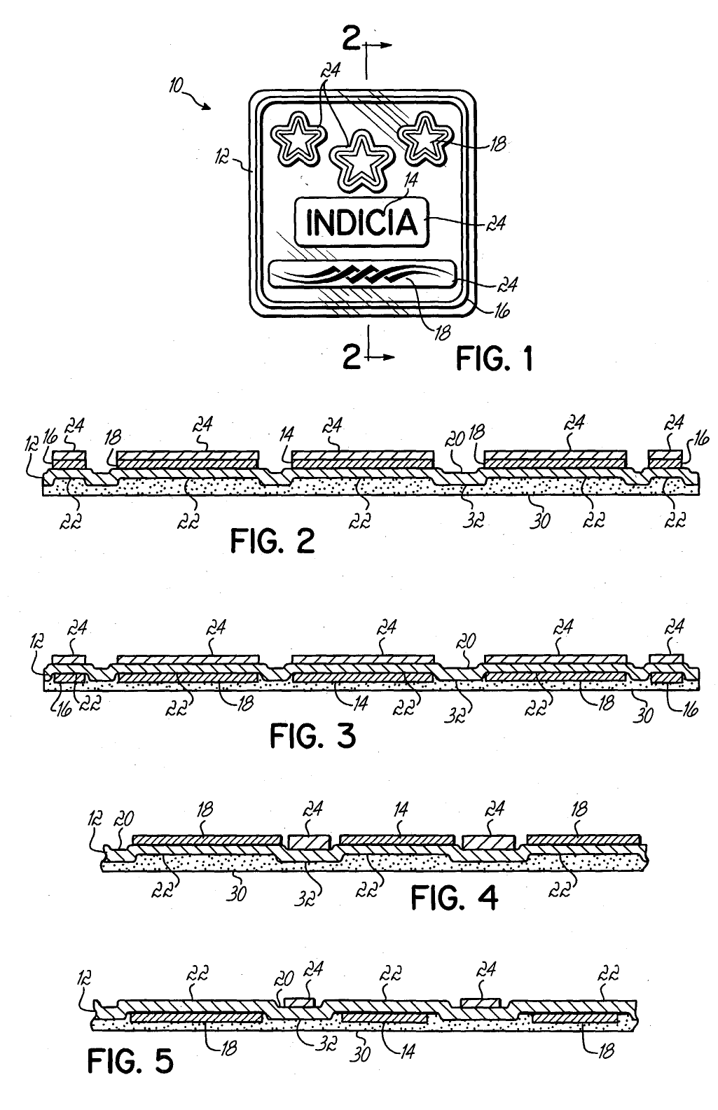

Referring to FIG. 1, there is shown an exemplary label 10 of the present invention. The label includes a facestock 12, which may be cut or otherwise formed into a discrete label shape, and visible indicia 14, 16, 18 selectively applied to a first side 20 of the facestock 12 to create letters, numbers, borders, decorative designs, or any combination thereof. In the exemplary embodiment, the facestock 12 is formed from cellulose film material, such as cellophane or cellulose acetate, but it will be understood that the facestock 12 may be formed from any other material suitable for making labels, such as paper or other polymeric materials, such as polyethylene, polypropylene, PVC or other suitable materials. The visible indicia 14, 16, 18 of the exemplary label 10 are created by applying ink to the facestock 12 by methods known in the art, such as screen printing, gravure printing, lithography, flexography, or any other method suitable for creating the desired indicia 14, 16, 18. The indicia 14, 16, 18 may also comprise hot stamped foil applied to the facestock 12.

As depicted most clearly in FIG. 2, label 10 further includes embossed areas 22, formed in facestock layer 12 to create distinct raised portions on the label 10. In the exemplary embodiment shown, the embossed areas 22 correspond to areas of facestock layer 12 to which visible indicia 14, 16, 18 have been applied to thereby provide relief in the areas of the indicia 14, 16, 18. These raised portions enhance the aesthetic appearance of the label 10 by giving the label 10 tactile feel. While the exemplary embodiments shown and described herein illustrate embossed areas 22 formed in facestock layer 12, it will be understood that these areas could alternatively be debossed to create distinct depressed portions on the label 10. Accordingly, the various aspects and advantages of labels 10 described herein with respect to embossed areas 22 also apply to labels 10 having debossed areas. Furthermore, it will be understood that labels 10 may alternatively have both embossed and debossed areas formed into facestock layer 12.

With further reference to FIG. 2, the exemplary label 10 may further include one or more layers of tactile coating 24 selectively applied to discrete areas of the first side of the facestock 12 to create distinct raised portions on the label 10 as discussed in copending U.S. Patent Application Serial No. 60/389,633, filed Jun. 18, 2002, assigned to the Assignee of the present invention and herein incorporated by reference in its entirety. When tactile coating 24 is applied to the facestock 12 in areas corresponding to the location of embossed areas 22, an even greater relief is created on the label 10 to further enhance tactile feel of the label 10. In the exemplary embodiment shown in FIGS. 1 and 2, the embossed areas 22 and tactile coating layers 24 are applied to areas proximate the indicia 14, 16, 18, whereby the areas overlying the indicia 14, 16, 18 are elevated with respect to the surrounding portions of the label 10. It will be recognized, however, the tactile coating 24 may alternatively be applied to areas of facestock 12 not corresponding to embossed areas 22, or indicia 14, 16, 18, as will be discussed more fully below. In the exemplary label 10, the tactile coating 24 is a UV cured acrylic coating, such as Clear Extender No. 4929 available from Sun Chemical Corporation, Northlake, Ill., but other coatings suitable for application to a label and which can be applied in successive layers may be used as well.

With continued reference to FIG. 2, the label 10 further includes an adhesive layer 30 which is applied to a second side 32 of the facestock 12, generally opposite the first side 20 on which the indicia 14, 16, 18 and tactile coating 24 are applied. Adhesive 30 may be applied to label 10 by the label manufacturer, or it may be applied immediately prior to application of the label to a container. When the labels 10 are provided in “cut-and-stack” form, the labels 10 are generally provided without adhesive 30 and the labeling machine includes a station for applying the adhesive 30 prior to application on the containers. The adhesive 30 may be a pressure-sensitive adhesive, heat-activated adhesive, water-activated adhesive, solvent-based, acrylic-based, or any other type of adhesive which is suitable for adhering a label 10 to a surface. In a preferred embodiment, the adhesive 30 is transparent; adheres to glass, polymeric materials, and cellulose film materials such as cellophane and cellulose acetate; sets quickly; and is relatively impervious to moisture and temperature fluctuations.

Referring now to FIG. 3, there is shown another exemplary embodiment of the label 10 wherein the indicia 14, 16, 18 are applied to the second side 32 of the facestock 12 in areas corresponding to embossed areas 22 of facestock 12. When the facestock 12 is formed from a clear or partially transparent cellulose film material, the indicia 14, 16, 18 will be viewable from the first side 20 of the facestock 12. Accordingly, the images and lettering comprising the indicia 14, 16, 18 will generally be applied to the second side 32 in reverse image so that they may be properly viewed from the first side 20. Advantageously, the clear cellulose film material provides a protective barrier for the visible indicia 14, 16, 18 and the embossed areas provide relief to the indicia 14, 16, 18 to create a tactile feel for the label 12. In this embodiment, tactile coating layers 24 may be selectively applied to discrete areas of the first side 20 of the facestock 12 corresponding to the embossed areas 22 and indicia 14, 16, 18 to further enhance tactile feel.

FIGS. 4 and 5 depict exemplary embodiments of label 10 wherein facestock 12 has been formed with embossed areas 22 and wherein tactile coating 24 has been selectively applied to the first side 20 of facestock 12 to create distinct raised portions. In these embodiments, however, tactile coating 24 is applied to areas of facestock 12 not corresponding to embossed areas 22 or indicia 14, 16, 18. These embodiments may be useful to provide raised portions of label 12 when it is desired to provide tactile feel in areas of label 12 not having visible indicia 14, 16, 18 which would otherwise conceal irregularities in the facestock 12 that may occur as a result of embossing facestock 12. Such configurations are particularly important when facestock 12 comprises clear or transparent material. FIG. 4 depicts an embodiment wherein indicia 14, 16, 18 are applied to the first side 20 of facestock 12. FIG. 5 depicts an embodiment wherein indicia 14, 16, 18 are applied to the second side 32 of facestock 12.

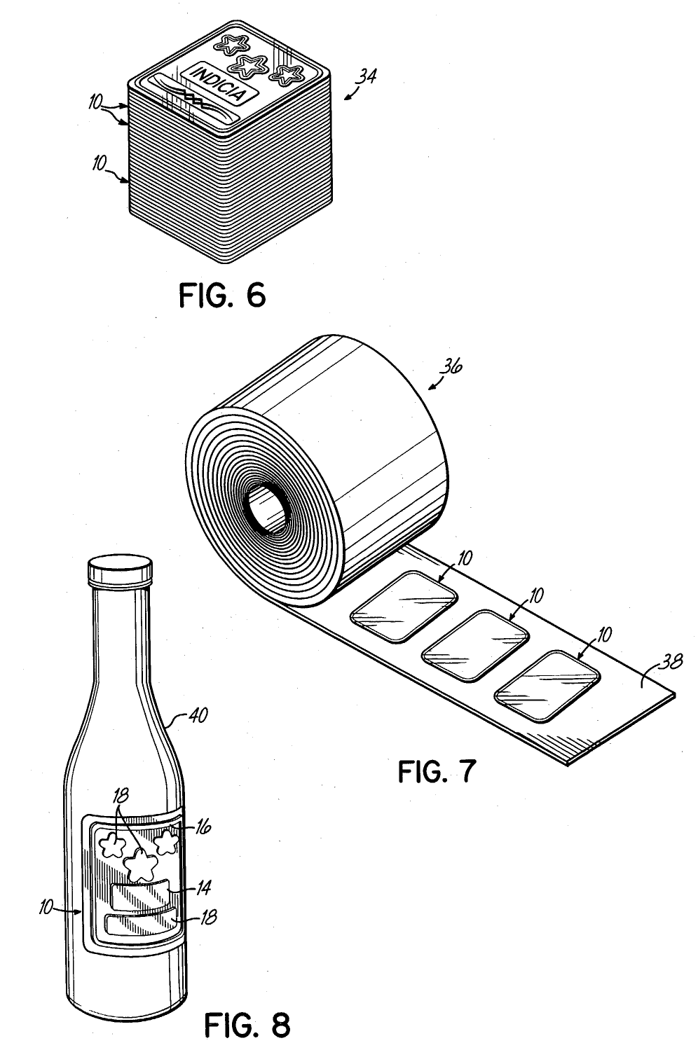

The exemplary embodiments described above provide relatively low cost labels having tactile feel for improved aesthetic appearance. Furthermore, it has been discovered that labels made from facestock material comprising cellulose film, such as cellophane or cellulose acetate, may be applied to containers by automated “cut-and stack” labeling machines. Advantageously, a plurality of labels constructed as described above may be provided in a stack 34, commonly referred to as “cut-and-stack” form, as depicted in FIG. 6, for dispensing and application to individual containers by a labeling machine. Adhesive 30 may be applied to the second sides 32 of labels 10 of stack 34 as pre-applied adhesive, or it may be applied prior to application of the labels 10 to containers. Alternatively, adhesive 30 may be applied to the first side 20 of facestock 12, over the indicia 14, 16, 18. This construction may be used when the facestock 12 is at least partially transparent, whereby indicia 14, 16, 18 printed in reverse image will be visible through the facestock 12.

Alternatively, a plurality of labels constructed as described above may be provided on a web of liner material 38 formed into a roll 36, as depicted in FIG. 7. The construction of labels 10 in roll form, and the dispensing and application of such labels to individual containers by an automated labeling machine having at least one dispensing station with a peel tip, is described in copending U.S. patent application Ser. No. 10/166,276 filed Jun. 10, 2002, assigned to the Assignee of the present invention and incorporated by reference herein in it entirety.

Referring to FIG. 8, there is shown an exemplary container 40 including a label 10 of the present invention. Advantageously, the raised portions of the inventive label 10 provide a tactile feel to the label 10 which is not present on prior art labels. The tactile feel may provide a gripping surface for a container 40 to which the label is applied, and/or may increase the aesthetic appearance of the labels 10. The label 10 may be applied to the container 40 by various means, such as by automatic equipment configured to receive labels 10 provided in roll or “cut-and-stack” form, dispense individual labels 10 from the stack or roll, and apply the labels 10 to individual containers 40.

In another exemplary embodiment, a label 10 according to the present invention may be made from a facestock 12 in the form of an elongate sheet of cellulose film material, such as cellophane or cellulose acetate. Embossed areas 22 are formed in facestock 12 to create distinct raised portions. The facestock 12 has a first side 20 and a second 32 and visible indicia 14, 16, 18 are applied to selective portions of one or both sides 20, 32 of the facestock 12, to create letters, numbers, borders, backgrounds, decorative designs, or various combinations thereof. The indicia 14, 16, 18 may comprise printed inks or hot stamped foil and may correspond to embossed areas 22 of facestock 12, as may be desired, to provide a tactile feel that enhances the aesthetic effects of the label. One or more tactile coating layers 24 may also be applied to discrete areas of the facestock 12 to create distinct raised portions on the label 10. In one embodiment, the elongate sheet of cellulose film material is cut, or otherwise formed into discrete label shapes, whereafter the individual labels may be arranged in a stack 34, as depicted in FIG. 6. In another embodiment, the elongate sheet of cellulose film material may be coated with adhesive and joined to a web of liner material 38. The cellulose film sheet may then be die cut to define discrete label shapes and the plurality of labels on the web of liner material formed into a roll, as depicted in FIG. 7 and described more fully in copending U.S. patent application Ser. No. 10/166,276.

While the present invention has been illustrated by the description of the various embodiments thereof, and while the embodiments have been described in considerable detail, it is not intended to restrict or in any way limit the scope of the appended claims to such detail. Additional advantages and modifications will readily appear to those skilled in the art. The invention in its broader aspects is therefore not limited to the specific details, representative apparatus and methods and illustrative examples shown and described. Accordingly, departures may be made from such details without departing from the scope or spirit of the general inventive concept.

Additional advantages and modifications will readily appear to those skilled in the art. The invention in its broader aspects is therefore not limited to the specific details, representative apparatus and methods and illustrative examples shown and described. Accordingly, departures may be made from such details without departing from the scope or spirit of the general inventive concept.

What is claimed is:

1. A label, comprising:
a facestock layer comprising cellulose film material and having a first side and a second side;
visible indicia selectively applied to one or more portions of at least one of said first and second sides of said facestock layer; and
at least one embossed or debossed area selectively formed in said facestock layer.

2. The label of claim 1, wherein said cellulose film material is cellophane.

3. The label of claim 1, wherein said cellulose film material is cellulose acetate.

4. The label of claim 1, wherein said embossed or debossed area corresponds to at least a portion of said selectively applied visible indicia.

5. The label of claim 1, wherein said embossed or debossed area and said visible indicia do not correspond to one another.

6. The label of claim 1, further comprising an adhesive layer applied to said second side of said facestock layer.

7. The label of claim 6, wherein said visible indicia are selectively applied to said second side of said facestock layer.

8. The label of claim 1, further comprising at least one tactile coating layer selectively applied to discrete portions of said first side of said facestock layer to create discrete raised portions on the label for tactile feel.

9. The label of claim 8, wherein said tactile coating layer corresponds to at least a portion of said visible indicia.

10. The label of claim 8, wherein said tactile coating layer and said visible indicia do not correspond to one another.

11. The label of claim 8, wherein said visible indicia, said embossed or debossed area, and said tactile coating layer are located on a corresponding portion of said facestock layer.

12. The label of claim 8, wherein said visible indicia and said embossed or debossed area are located on a corresponding portion of said facestock layer, and said tactile coating layer is located on a portion of said facestock layer, not corresponding to said visible indicia and said embossed or debossed area.

13. A labeled product package, comprising:
a container having a surface for receiving a label; and
a label disposed on said surface, said label comprising:
a facestock layer comprising cellulose film material and having a first side and a second side,
visible indicia selectively applied to one or more portions of at least one of said first and second sides of said facestock layer,
at least one embossed or debossed area selectively formed in said facestock layer, and
an adhesive layer applied to said second side of said facestock layer.

14. The labeled product package of claim 13, wherein said cellulose film material is cellophane.

15. The labeled product package of claim 13, wherein said cellulose film material is cellulose acetate.

16. The labeled product package of claim 13, further comprising:
at least one tactile coating layer selectively applied to discrete portions of said first side of said facestock layer to create distinct raised portions on the label of tactile feel.

17. A supply of labels, comprising:
a plurality of labels arranged in a stack, each of said labels comprising:
a facestock layer comprising cellulose film material and having a first side and a second side,
visible indicia selectively applied to one or more portions of at least one of said first and second sides of said facestock layer, and
at least one embossed or debossed area selectively formed in said facestock layer.

18. The supply of labels of claim 17, wherein said cellulose film material is cellophane.

19. The supply of labels of claim 17, wherein said cellulose film material is cellulose acetate.

20. The supply of labels of claim 17, wherein each of said labels further comprises an adhesive layer applied to said second side of said facestock layer.

21. The supply of labels of claim 17, wherein each of said labels further comprises at least one tactile coating layer selectively applied to discrete portions of said first side of said facestock layer to create distinct raised portions on the label for tactile feel.

22. A supply of labels, comprising:
an elongate web of liner material for supporting labels;
a plurality of discrete labels releasably disposed on said liner material; and
an adhesive layer applied to said second side of said facestock layer, between said facestock layer and said liner material;
each of said labels comprising:
a facestock layer comprising cellulose film material and having a first side and a second side,
visible indicia selectively applied to one or more portions of at least one of said first and second sides of said facestock layer, and
at least one embossed or debossed area selectively formed in said facestock layer.

23. The supply of labels of claim 22, wherein said cellulose film material is cellophane.

24. The supply of labels of claim 22, wherein said cellulose film material is cellulose acetate.

25. The supply of labels of claim 22, wherein each of said labels further comprises at least one tactile coating layer selectively applied to discrete portions of said first side of said facestock layer to create distinct raised portions on the label for tactile feel.

26. A method of making a label from cellulose film material having first and second sides, comprising:
selectively embossing or debossing portions of the cellulose film material; and
selectively applying indicia to at least one of the first and second sides of the cellulose film material.

27. The method of claim 26, wherein the cellulose film material is cellophane.

28. The method of claim 26, wherein the cellulose film material is cellulose acetate.

29. The method of claim 26, further comprising applying adhesive to the second side of the cellulose film material.

30. The method of claim 26, further comprising selectively applying at least one tactile coating layer to the first side of the cellulose film material to create distinct raised portions on the cellulose film material for tactile feel.

31. The method of claim 26, wherein the cellulose film material is in the form of an elongate sheet, the method further comprising forming discrete label shapes in the elongate sheet of cellulose film material.

32. The method of claim 31, further comprising arranging a plurality of labels in a stack.

33. The method of claim 26, wherein the cellulose film material is in the form of an elongate sheet, the method further comprising:
joining the cellulose film material to a web of liner material;
forming discrete label shapes in the elongate sheet of cellulose film material; and
forming the sheet of cellulose film material and web of liner material into a roll.
